(19) United States
(12) Patent Application Publication
(10) Pub. No.: US 2004/0114395 A1
(43) Pub. Date: Jun. 17, 2004

(54) Direct-type backlight module

(76) Inventors: Ching-Hsiang Chan, Hsinchu (TW); Ming-Chun Hsiao, Hsinchu (TW); Kang-Hung Liu, Hsinchu (TW); Wai-Yi Lin, Yunlin (TW)

Correspondence Address: BIRCH STEWART KOLASCH & BIRCH, PO BOX 747, FALLS CHURCH, VA, 22040-0747, US

(21) Appl. No.: 10/348,953

(22) Filed: Jan. 23, 2003

(30) Foreign Application Priority Data
Dec. 17, 2002 (TW) 91136406

(51) Int. Cl. F21V 7/04

(52) U.S. Cl. 362/560; 362/224; 362/297; 362/331; 362/339

(57) ABSTRACT

A direct-type backlight module. The direct-type backlight module includes a first diffuser, a prism, a second diffuser, a reflector and a tube. The prism is disposed under the first diffuser. The second diffuser is disposed under the prism. The reflector is disposed under the second diffuser and has a plurality of protruding reflecting portions. The protruding reflecting portions are separated from each other by a predetermined distance. The tube is disposed between the second diffuser and the reflector. The tube is positioned between two contiguous protruding reflecting portions of the reflector. Light emitted from the tube is reflected upward into the second diffuser, the prism and the first diffuser by the reflector and the protruding reflecting portions.

### BACKGROUND OF THE INVENTION

1. Field of the Invention

The invention relates to a direct-type backlight module, and more particularly to a direct-type backlight module that effectively utilizes light from a tube and thereby enhances illumination.

2. Description of the Related Art

FIG. 1 shows a conventional direct-type backlight module 1. Because the reflector 11 of the conventional direct-type backlight module 1 is a flat structure, light from a tube 12 is transmitted sideward and enters other tubes 12. The light entering other tubes 12 is almost ineffective, thus reducing optical utility of the tubes 12.

SUMMARY OF THE INVENTION

The present invention is directed to a direct-type backlight module having a simplified structure and reducing ineffective light entering the tubes. Light emitted from the tubes is fully utilized by means of a particular protruding structure on the reflector of the direct-type backlight module. The light transmitted sideward is reflected upward by the particular protruding structure on the reflector of the direct-type backlight module, such that illumination thereof is enhanced, electricity consumption is reduced, and manufacturing costs are decreased.

An object of the invention is thus to provide a direct-type backlight module. The direct-type backlight module comprises a first diffuser, a prism, a second diffuser, a reflector and a tube. The prism is disposed under the first diffuser. The second diffuser is disposed under the prism. The reflector is disposed under the second diffuser and has a plurality of protruding reflecting portions. The protruding reflecting portions are separated from each other by a predetermined distance, The tube is disposed between the second diffuser and the reflector and positioned between two contiguous protruding reflecting portions of the reflector.

Preferably, the protruding reflecting portions of the reflector are triangular prisms, or the cross section of each protruding reflecting portion of the reflector is composed of two curved surfaces and a straight line.

Preferably, each protruding reflecting portion of the reflector further comprises a plurality of triangular reflecting surfaces formed thereon.

Preferably, a plurality of fins are disposed under the reflector for enhancing heat dissipation thereof.

Preferably, the surfaces of the reflector and the protruding reflecting portions are electroplated with a reflective material.

Preferably, the surfaces of the reflector and the protruding reflecting portions are electroplated with the reflective material by physical vapor deposition (PVD).

Preferably, the reflective material is chromium or aluminum.

Preferably, the tube is a straight tube or a curved tube.

The invention also provides a direct-type backlight module. The direct-type backlight module comprises a first diffuser, a prism, a second diffuser, a reflector and a tube. The prism is disposed under the first diffuser. The second diffuser is disposed under the prism. The reflector is disposed under the second diffuser and composed of a plurality of triangular reflecting portions. The tube is disposed between the second diffuser and the reflector and positioned between two contiguous triangular reflecting portions of the reflector.

Preferably, each triangular reflecting portion of the reflector further comprises a plurality of triangular reflecting surfaces formed thereon.

Preferably, a plurality of fins are disposed under the reflector for enhancing heat dissipation thereof.

Preferably, the surfaces of the triangular reflecting portions are electroplated with a reflective material.

Preferably, the surfaces of the reflector and the protruding reflecting portions are electroplated with the reflective material by physical vapor deposition (PVD), Preferably, the reflective material is chromium or aluminum.

Preferably, the tube is a straight tube or a curved tube.

### DESCRIPTION OF THE DRAWINGS

For a better understanding of the present invention, reference in made to a detailed description to be read in conjunction with the accompanying drawings, in which:

FIG, 1 shows a conventional direct-type backlight module;

FIG. 2A shows the direct-type backlight module of the first embodiment of the invention;

FIG. 2B shows the protruding reflecting portion having a plurality of triangular reflecting surfaces according to FIG. 2A;

FIG. 3A is a diagram showing the optical measurements of the conventional direct-type backlight module according to FIG. 1;

FIG. 3B is a diagram showing the optical measurements of the direct-type backlight module according to FIG. 2A;

FIG. 4 shows the direct-type backlight module of the second embodiment of the invention; and

FIG. 5 shows the direct-type backlight module of the third embodiment of the invention.

### DETAILED DESCRIPTION OF THE INVENTION

### First embodiment

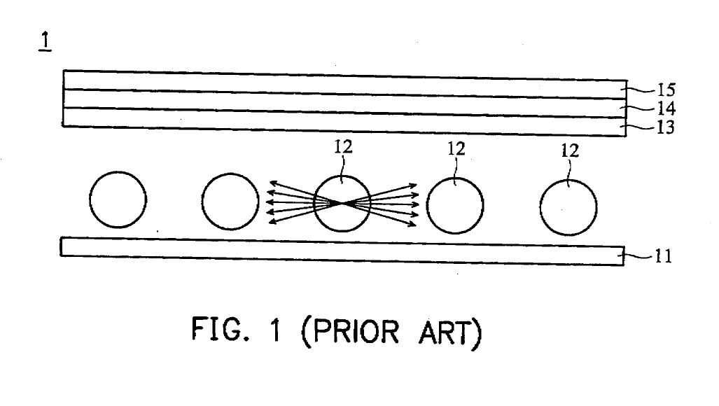

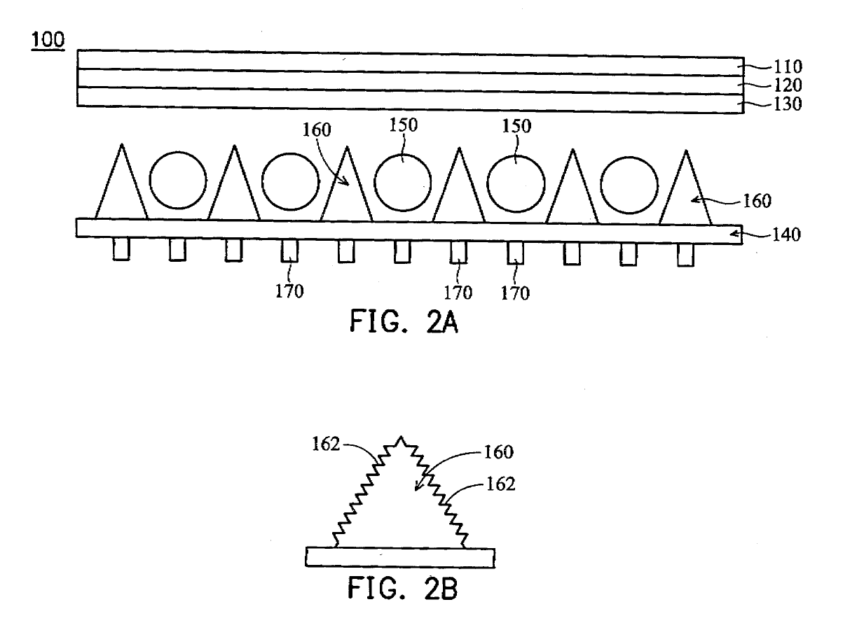

Referring to FIG. 2A, the direct-type backlight module 100 comprises a first diffuser 110, a prism 120, a second diffuser 130, a reflector 140 and a plurality of tubes 150. The prism 120 is disposed under the first diffuser 110. The second diffuser 130 is disposed under the prism 120. The reflector 140 is disposed under the second diffuser 130. The tubes 150 are disposed between the second diffuser 130 and the reflector 140.

In addition, on the reflector 140, a plurality of protruding reflecting portions 160 are equidistantly separated from each other. Each tube 150 is positioned between two contiguous protruding reflecting portions 160. In this embodiment, the tubes 150 can be straight tubes or curved tubes. The protruding reflecting portions 160 are triangular prisms and made of the same material as the reflector 140. Meanwhile, the surfaces of the protruding reflecting portions 160 and the reflector 140 are electroplated with a reflective material such as chromium or aluminum. The reflective material can be electroplated on the surfaces of the protruding reflecting portions 160 and the reflector 140 by physical vapor deposition (PVD), Thus, light emitted from the tubes 150 is reflected upward into the second diffuser 130, the prism 120 and the first diffuser 110 by the reflector 140 and the protruding reflecting portions 160.

Accordingly, as shown in FIG. 21, a plurality of minor triangular reflecting surfaces 162 are formed on each protruding reflecting portion 160 of the reflector 140 for enhancing light reflection thereof.

Additionally, when the tubes 150 emit light, heat generated by the tubes 150 is transferred to the reflector 140. Thus, a plurality of fins 170 are disposed under the reflector 140 for enhancing heat dissipation thereof, as shown in FIG. 2A.

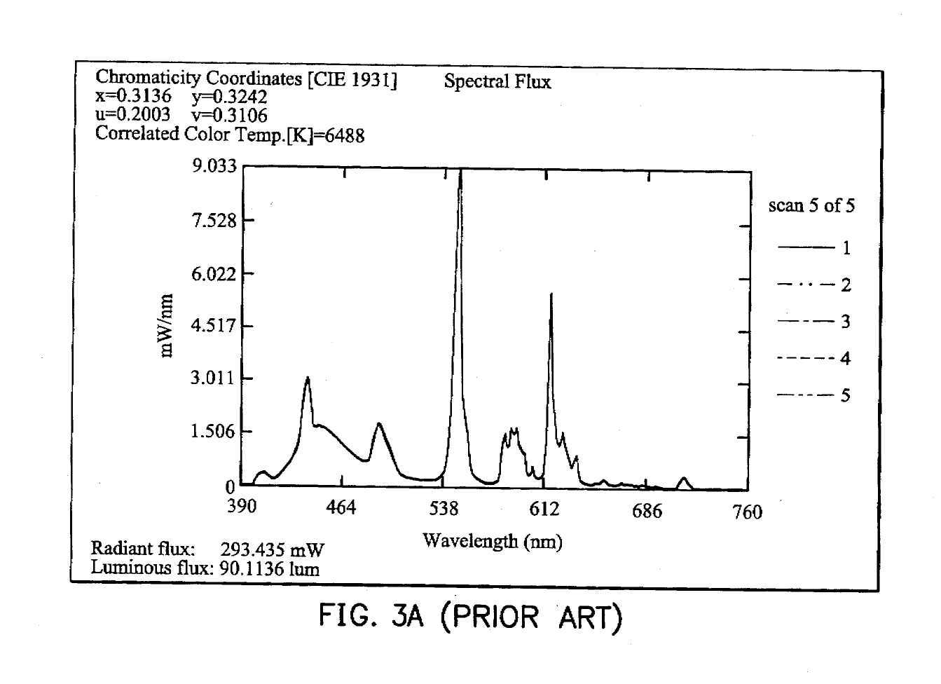

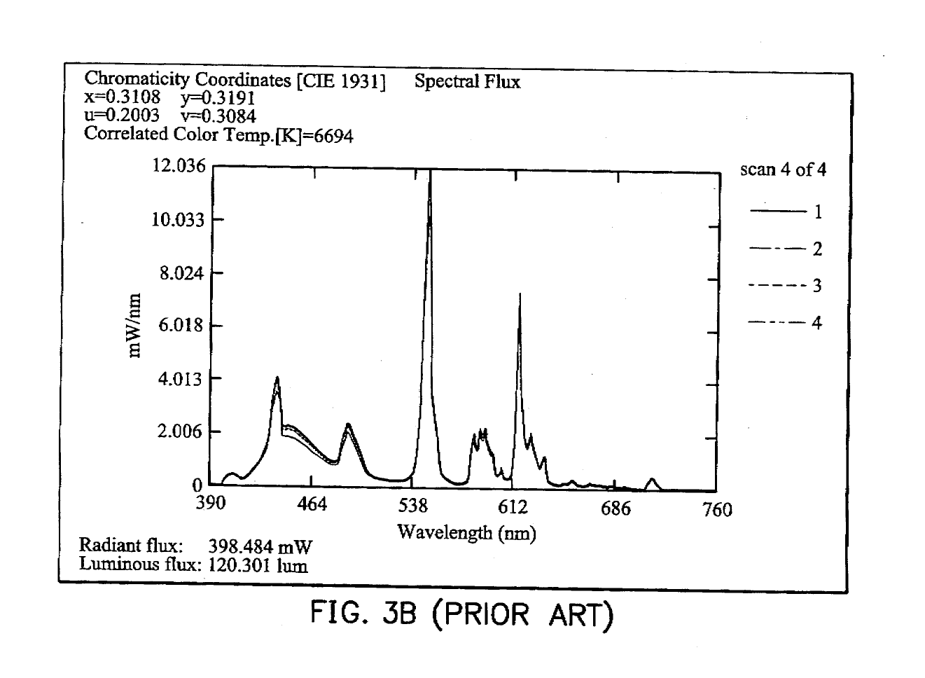

FIG. 3A is a diagram showing the optical measurements of the conventional direct-type backlight module 1 and FIG. 3B is a diagram showing the optical measurements of the direct-type backlight module 100. In order to verify illumination difference between the conventional direct-type backlight module 1 and the present direct-type backlight module 100, the two direct-type backlight modules 1 and 100 are placed in an integrating sphere to be detected and thereby spectrums of red (R), green (G) and blue (B) rays and luminous flux are obtained. In this experiment, both the direct-type backlight modules 1 and 100 are equipped with eight tubes (CCFL). As shown in FIG. 3A and FIG. 3B, under the same conditions, the luminous flux of the direct-type backlight module 1 is 90.1136 lum while that of the direct-type backlight module 100 is 120.301 lum. Thus, according to the experiment, the illumination of the direct-type backlight module 100 is greatly enhanced compared with that of the direct-type backlight module 1. In other words, the light transmitted sideward from each tube 150 in the direct-type backlight module 100 is completely reflected upward without the ineffective light entering other tubes 150.

Accordingly, since the illumination of the direct-type backlight module 100 is enhanced, the number of the tubes 150 disposed therein can be reduced to provide the same illumination as the direct-type backlight module 1. Thus, power for the tubes can be conserved,

### Second embodiment

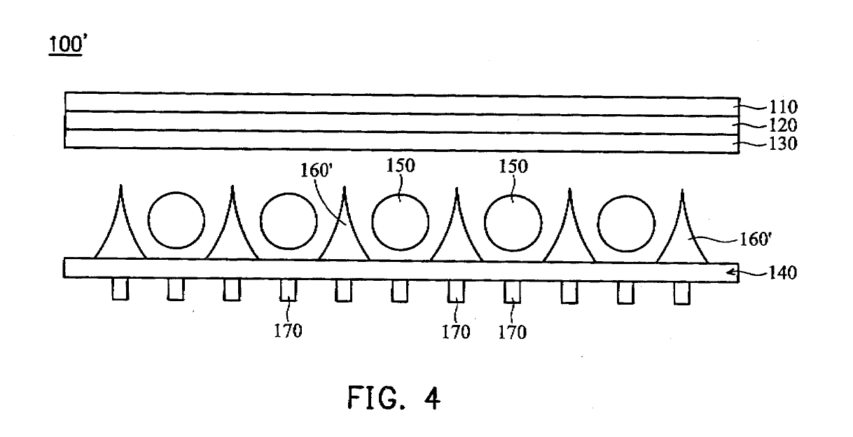

Referring to FIG. 4, the difference between this embodiment and the first embodiment is the configuration of the protruding reflecting portion of the reflector 140. The cross section of each protruding reflecting portion 160′ of the direct-type backlight module 100′ is composed of two curved surfaces and a straight line. Elements corresponding to those shown in FIG. 2A are given the same reference numerals, and explanation thereof will be omitted for simplification of the description.

Similarly, light emitted from the tubes 150 is reflected upward into the second diffuser 130, the prism 120 and the first diffuser 110 by the reflector 140 and the protruding reflecting portions 160′. Thus, there is no ineffective light entering the tubes 150, and the illumination of the direct-type backlight module 100′ is thereby enhanced,

### Third embodiment

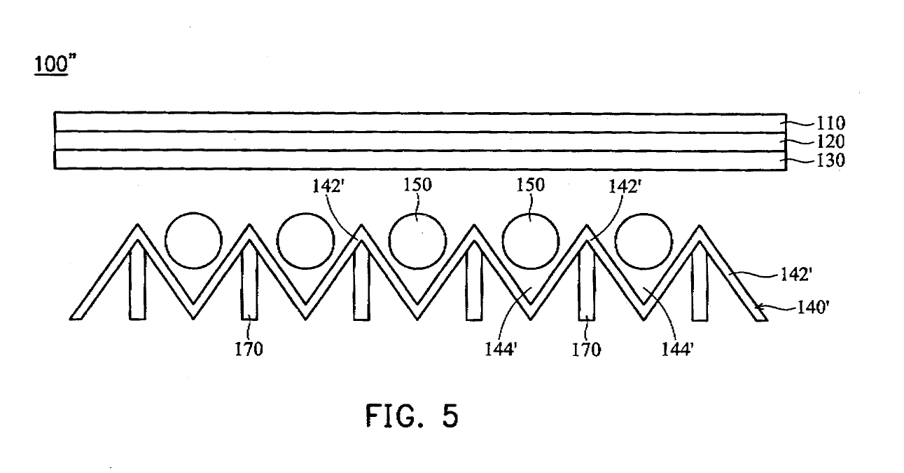

Referring to FIG. 5, this embodiment differs from the first and second embodiments in that the reflector 140′ of the direct-type backlight module 100′ is composed of a plurality of triangular reflecting portions 142′ and thereby has a saw-toothed structure. Meanwhile, each tube 150 is positioned between two contiguous protruding reflecting portions 142′ of the reflector 140′. Elements corresponding to those shown in FIG. 2A are given the same reference numerals, and explanation thereof will be omitted for simplification of the description.

Similarly, light emitted from the tubes 150 is reflected upward into the second diffuser 130, the prism 120 and the first diffuser 110 by the triangular reflecting portions 142′. Thus, there is no ineffective light entering the tubes 150, and the illumination of the direct-type backlight module 100″ is thereby enhanced.

In addition, as shown in FIG. 5, a recess 144′ is formed between two contiguous triangular reflecting portions 142′ of the reflector 140′. The recesses 144′ and the fins 170 disposed under the reflector 140′ can enhance heat dissipation thereof.

Similarly, a plurality of minor triangular reflecting surfaces (not shown) are formed on each triangular reflecting portion 142′ of the reflector 140′ for enhancing light reflection thereof.

To conclude, the direct-type backlight module of the invention has many advantages, Namely, the illumination thereof is enhanced, the number of tubes can be reduced and thereby power can be conserved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art).

Therefore, the scope of the appended claims should be accorded the broadest interpretation so as to encompass all such modifications and similar arrangements.

What is claimed is:

1. A direct-type backlight module, comprising:
a first diffuser;
a prism disposed under the first diffuser;
a second diffuser disposed under the prism;
a reflector disposed under the second diffuser and having a plurality of protruding reflecting portions, wherein the protruding reflecting portions are separated from each other by a predetermined distance; and
a tube disposed between the second diffuser and the reflector, wherein the tube is positioned between two contiguous protruding reflecting portions of the reflector.

2. The direct-type backlight module as claimed in claim 1, wherein the protruding reflecting portions of the reflector are triangular prisms.

3. The direct-type backlight module as claimed in claim 1, wherein the cross section of each protruding reflecting portion of the reflector is composed of two curved surfaces and a straight line.

4. The direct-type backlight module as claimed in claim 2, wherein each protruding reflecting portion of the reflector further comprises a plurality of triangular reflecting surfaces formed thereon.

5. The direct-type backlight module as claimed in claim 1, wherein a plurality of fins are disposed under the reflector for enhancing heat dissipation thereof.

6. The direct-type backlight module as claimed in claim 1, wherein the surfaces of the reflector and the protruding reflecting portions are electroplated with a reflective material.

7. The direct-type backlight module as claimed in claim 6, wherein the surfaces of the reflector and the protruding reflecting portions are electroplated with the reflective material by physical vapor deposition (PVD).

8. The direct-type backlight module as claimed in claim 6, wherein the reflective material is chromium or aluminum.

9. The direct-type backlight module as claimed in claim 1, wherein the tube is a straight tube.

10. The direct-type backlight module as claimed in claim 1, wherein the tube is a curved tube.

11. A direct-type backlight module, comprising:
a first diffuser;
a prism disposed under the first diffuser;
a second diffuser disposed under the prism;
a reflector disposed under the second diffuser, wherein the reflector is composed of a plurality of triangular reflecting portions; and
a tube disposed between the second diffuser and the reflector, wherein the tube is positioned between two contiguous triangular reflecting portions of the reflector.

12. The direct-type backlight module as claimed in claim 11, wherein each triangular reflecting portion of the reflector further comprises a plurality of triangular reflecting surfaces formed thereon.

13. The direct-type backlight module as claimed in claim 11, wherein a plurality of fins are disposed under the reflector for enhancing heat dissipation thereof.

14. The direct-type backlight module as claimed in claim 11, wherein a recess is formed between two contiguous triangular reflecting portions of the reflector.

15. The direct-type backlight module as claimed in claim 11, wherein the surfaces of the triangular reflecting portions are electroplated with a reflective material.

16. The direct-type backlight module as claimed in claim 15, wherein the surfaces of the triangular reflecting portions are electroplated with the reflective material by physical vapor deposition (PVD).

17. The direct-type backlight module as claimed in claim 15, wherein the reflective material is chromium or aluminum.

18. The direct-type backlight module as claimed in claim 11, wherein the tube is a straight tube.

19. The direct-type backlight module as claimed in claim 11, wherein the tube is a curved tube.
